(19) United States
(12) Patent Application Publication
(10) Pub. No.: US 2004/0148169 A1
(43) Pub. Date: Jul. 29, 2004

(54) Speech recognition with shadow modeling

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/348,967

(22) Filed: Jan. 23, 2003

(51) Int. Cl. G10L 15/04

(52) U.S. Cl. 704/254

(57) ABSTRACT

A speech recognition method, system and program product for the context of an existing model for a speech element, the method comprising in one embodiment: detecting an unusual instance of the speech; creating a new model to recognize the unusual instance of the speech element; computing a score for both the existing model by itself and the new model on new speech data; determining a comparative accuracy parameter for each of the models; and selecting to keep the existing model, or to keep the new model, or to keep both the existing model and the new model based on the comparative accuracy parameters of the respective models.

### BACKGROUND OF THE INVENTION

For an element of speech such as a word, a phoneme, a syllable, or a state, that is not well modeled by an existing model, there is a need to provide a system flexibility to create a new model for improved accuracy as unusual instances of speech data are received. There may also be situations where there may be a need to create a new model based on a single instance of the unusual instance. Examples of a situation where a new model may be needed include multiple pronunciations for a word or a syllable. An indication of a need for a new model may be a clear recognition error or an unusually poor score for a known correct choice.

### SUMMARY OF THE INVENTION

One embodiment of the present invention is a speech recognition method in the context of an existing model for a speech element, comprising: detecting an unusual instance of the speech element; creating a new model to recognize the unusual instance of the speech element; computing a score for both the existing model by itself and the new model on new speech data; determining a comparative accuracy parameter for each of the models; and selecting to keep the existing model, or to keep the new model, or to keep both the existing model and the new model based on the comparative accuracy parameters of the respective models.

In a further embodiment of the present invention, the step of determining an accuracy parameter for each model comprises: determining if the speech element is present in the new speech data; and determining the comparative accuracy parameter for one of the models based on whether the score for that model was higher or lower than the other of the models and based on whether the speech element was present in the new speech data.

In a further embodiment of the present invention, the step is provided of selecting a hypothesis as a recognized hypothesis.

In a further embodiment of the present invention, the recognized hypothesis is displayed in order to receive explicit or implicit correction input.

In a further embodiment of the present invention, the selecting a hypothesis step comprises, if one hypothesis ranks best when ranked using the score from one of the models of a given speech element and hypothesizes an instance of the given speech element, and a different hypothesis ranks best when ranked using the scores from the other model of the given speech element and does not hypothesize an instance of the given speech element, then the portion of the time that the models are used to determine the selection of the hypothesis as the recognized hypothesis, is determined randomly.

In a further embodiment of the present invention, the steps are provided of ranking a hypothesis among a list of hypotheses based at least in part on the score computed for the existing model; ranking the hypothesis among a list of hypotheses based at least in part on the score computed for the hybrid model; and determining if the speech element represented by the hypothesis is present in the new speech data; and determining the comparative accuracy parameter for each of the existing model and the hybrid model based on whether the score for that model was higher or lower than the other of the models and based on whether the speech element represented by the hypothesis was present in the new speech data.

In a further embodiment of the present invention, if there is a correction or a confirmation, the rewards and penalties are made larger for a model that ranked its hypothesis higher in the list of hypotheses as compared to the rewards and penalties for a model that ranked its hypothesis lower in the list of hypotheses.

In a further embodiment of the present invention, the step is provided of training the new model.

In a further embodiment of the present invention, the step is provided of training the new model against previous instances of training data for the speech element being modeled.

In a further embodiment of the present invention, the step is provided of unsupervised training of the new model against instances of the speech element that have been recognized and not corrected.

In a further embodiment of the present invention, the creating a new model step comprises determining a mean for the new model based on a data value in the unusual instance, and using a variance from the existing model as the variance for the new model.

In a further embodiment of the present invention, the steps are provided of time aligning the unusual instance with the existing model; creating a network with a state per frame; and for each frame using the variance from the existing model time aligned with frame and using the acoustic parameters from frame as the mean.

In a further embodiment of the present invention, the comparative accuracy parameter is determined at least in part by a rate of correction by a user.

In a further embodiment of the present invention, the comparative accuracy parameter is determined at least in part by a rate of correction determined automatically by the use of extra knowledge.

In a further embodiment of the present invention, a speech recognition method is provided in the context of an existing model for a speech element, comprising: detecting an unusual instance of the speech; creating a new model to recognize the unusual instance of the speech element; creating a hybrid model that includes the new and the existing models; computing a score for at least the existing model by itself and the hybrid model on new speech data; determining a comparative accuracy parameter for at least each of the existing model and the hybrid model; and selecting to keep the existing model, or to keep the hybrid model, or to keep both the existing model and the hybrid model based on the comparative accuracy parameters of the respective models.

In a further embodiment of the present invention, the hybrid model comprises modeling the speech element as being generated by a stochastic process that is a mixture distribution of the existing model and the new model.

In a further embodiment of the present invention, the mixture distribution is determined by matching the hybrid model to existing training data.

In a further embodiment of the present invention, a score is calculated for the new model, a comparative accuracy parameter is determined for the new model, and wherein the selecting step may include selecting the new model.

In a further embodiment of the present invention, the steps are provided of ranking a hypothesis within a list of hypotheses based at least in part on the score computed for the existing model; ranking the hypothesis within a list of hypotheses based at least in part on the score computed for the hybrid model; determining if the speech element represented by the hypothesis is present in the new speech data; and determining the comparative accuracy parameter for each of the existing model and the hybrid model based on whether the score for that model was higher or lower than the other of the models and based on whether the speech element represented by the hypothesis was present in the new speech data.

In a further embodiment of the present invention, a program product is provided for speech recognition in the context of an existing model for a speech element, comprising machine-readable program code for causing, when executed, a machine to perform the following method steps: detecting an unusual instance of the speech; creating a new model to recognize the unusual instance of the speech element; computing a score for both the existing model by itself and the new model on new speech data; determining a comparative accuracy parameter for each of the models; and selecting to keep the existing model, or to keep the new model, or to keep both the existing model and the new model based on the comparative accuracy parameters of the respective models.

In a further embodiment of the present invention, a program product is provided for speech recognition in the context of an existing model for a speech element, comprising machine-readable program code for causing, when executed, a machine to perform the following method steps: detecting an unusual instance of the speech; creating a new model to recognize the unusual instance of the speech element; creating a hybrid model that includes the new and the existing models; computing a score for at least the existing model by itself and the hybrid model on new speech data; determining a comparative accuracy parameter for at least each of the existing model and the hybrid model; and selecting to keep the existing model, or to keep the hybrid model, or to keep both the existing model and the hybrid model based on the comparative accuracy parameters of the respective models.

In a further embodiment of the present invention, a system is provided for speech recognition in the context of an existing model for a speech element, comprising: a component for detecting an unusual instance of the speech; a component for creating a new model to recognize the unusual instance of the speech element; a component for computing a score for both the existing model by itself and the new model on new speech data; a component for determining a comparative accuracy parameter for each of the models; and a component for selecting to keep the existing model, or to keep the new model, or to keep both the existing model and the new model based on the comparative accuracy parameters of the respective models.

In a further embodiment of the present invention, a system for speech recognition in the context of an existing model for a speech element, comprising: a component for detecting an unusual instance of the speech; a component for creating a new model to recognize the unusual instance of the speech element; a component for creating a hybrid model that includes the new and the existing models; a component for computing a score for at least the existing model by itself and the hybrid model on new speech data; a component for determining a comparative accuracy parameter for at least each of the existing model and the hybrid model; and a component for selecting to keep the existing model, or to keep the hybrid model, or to keep both the existing model and the hybrid model based on the comparative accuracy parameters of the respective models.

### BRIEF DESCRIPTION OF THE DRAWINGS

FIG. 1 is a flowchart for a method, system and program product in accordance with one embodiment of the present invention.

FIG. 2 is a flowchart for a method, system and program product in accordance with a second embodiment of the present invention.

### DETAILED DESCRIPTION OF THE PREFERRED EMBODIMENTS

### Definitions

The following terms may be used in the description of the invention and include new terms and terms that are given special meanings.

“Linguistic element” is a unit of written or spoken language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Priority queue.” in a search system is a list (the queue) of hypotheses rank ordered by some criterion (the priority). In a speech recognition search, each hypothesis is a set and possibly a sequence of speech elements or a combination of such sets and possibly sequences for different portions of the total interval of speech being analyzed. The priority criterion may be a score which estimates how well the hypothesis matches a set of observations, or it may be an estimate of the time at which the hypothesis begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Best first search” is a search method in which at each step of the search process one or more of the hypotheses from among those with estimated evaluations at or near the best found so far are chosen for further analysis.

“Breadth-first search” is a search method in which at each step of the search process many hypotheses are extended for further evaluation. A strict breadth-first search would always extend all shorter hypotheses before extending any longer hypotheses. In speech recognition whether one hypothesis is “shorter” than another (for determining the order of evaluation in a breadth-first search) is often determined by the estimated ending time of each hypothesis in the acoustic observation sequence. The frame-synchronous beam search is a form of breadth-first search, as is the multi-stack decoder.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Frame synchronous beam search” is a search method which proceeds frame-by-frame. Each active hypothesis is evaluated for a particular frame before proceeding to the next frame. The frames may be processed either forwards in time or backwards. Periodically, usually once per frame, the evaluated hypotheses are compared with some acceptance criterion. Only those hypotheses with evaluations better than some threshold are kept active. The beam consists of the set of active hypotheses.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Branch and bound search” is a class of search algorithms based on the branch and bound algorithm. In the branch and bound algorithm the hypotheses are organized as a tree. For each branch at each branch point, a bound is computed for the best score on the subtree of paths that use that branch. That bound is compared with a best score that has already been found for some path not in the subtree from that branch. If the other path is already better than the bound for the subtree, then the subtree may be dropped from further consideration. A branch and bound algorithm may be used to do an admissible A* search. More generally, a branch and bound type algorithm might use an approximate bound rather than a guaranteed bound, in which case the branch and bound algorithm would not be admissible. In fact for practical reasons, it is usually necessary to use a non-admissible bound just as it is usually necessary to do beam pruning. One implementation of a branch and bound search of the tree of possible sentences uses a priority queue and thus is equivalent to a type of stack decoder, using the bounds as look- ahead scores.

“Admissible A* search.” The term A* search is used not just in speech recognition but also to searches in a broader range of tasks in artificial intelligence and computer science. The A* search algorithm is a form of best first search that generally includes a look-ahead term that is either an estimate or a bound on the score portion of the data that has not yet been scored. Thus the A* algorithm is a form of priority queue search. If the look-ahead term is a rigorous bound (making the procedure “admissible”), then once the A* algorithm has found a complete path, it is guaranteed to be the best path. Thus an admissible A* algorithm is an instance of the branch and bound algorithm.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is grouping of speech elements, which may or may not be in sequence. However, in many speech recognition implementations, the hypothesis will be a sequence or a combination of sequences of speech elements. Corresponding to any hypothesis is a set of models, which may, as noted above in some embodiments, be a sequence of models that represent the speech elements. Thus, a match score for any hypothesis against a given set of acoustic observations, in some embodiments, is actually a match score for the concatenation of the set of models for the speech elements in the hypothesis.

“Set of hypotheses” is a collection of hypotheses that may have additional information or structural organization supplied by a recognition system. For example, a priority queue is a set of hypotheses that has been rank ordered by some priority criterion; an n-best list is a set of hypotheses that has been selected by a recognition system as the best matching hypotheses that the system was able to find in its search. A hypothesis lattice or speech element lattice is a compact network representation of a set of hypotheses comprising the best hypotheses found by the recognition process in which each path through the lattice represents a selected hypothesis.

“Selected set of hypotheses” is the set of hypotheses returned by a recognition system as the best matching hypotheses that have been found by the recognition search process. The selected set of hypotheses may be represented, for example, explicitly as an n-best list or implicitly as the set of paths through a lattice. In some cases a recognition system may select only a single hypothesis, in which case the selected set is a one element set. Generally, the hypotheses in the selected set of hypotheses will be complete sentence hypotheses; that is, the speech elements in each hypothesis will have been matched against the acoustic observations corresponding to the entire sentence. In some implementations, however, a recognition system may present a selected set of hypotheses to a user or to an application or analysis program before the recognition process is completed, in which case the selected set of hypotheses may also include partial sentence hypotheses. Such an implementation may be used, for example, when the system is getting feedback from the user or program to help complete the recognition process.

“Look-ahead” is the use of information from a new interval of speech that has not yet been explicitly included in the evaluation of a hypothesis. Such information is available during a search process if the search process is delayed relative to the speech signal or in later passes of multi-pass recognition. Look-ahead information can be used, for example, to better estimate how well the continuations of a particular hypothesis are expected to match against the observations in the new interval of speech. Look-ahead information may be used for at least two distinct purposes. One use of look-ahead information is for making a better comparison between hypotheses in deciding whether to prune the poorer scoring hypothesis. For this purpose, the hypotheses being compared might be of the same length and this form of look-ahead information could even be used in a frame-synchronous beam search. A different use of look-ahead information is for making a better comparison between hypotheses in sorting a priority queue. When the two hypotheses are of different length (that is, they have been matched against a different number of acoustic observations), the look-ahead information is also referred to as missing piece evaluation since it estimates the score for the interval of acoustic observations that have not been matched for the shorter hypothesis.

“Missing piece evaluation” is an estimate of the match score that the best continuation of a particular hypothesis is expected to achieve on an interval of acoustic observations that was yet not matched in the interval of acoustic observations that have been matched against the hypothesis itself. For admissible A* algorithms or branch and bound algorithms, a bound on the best possible score on the unmatched interval may be used rather than an estimate of the expected score.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Phoneme” is a single unit of sound in spoken language, roughly corresponding to a letter in written language.

“Phonetic label” is the label generated by a speech recognition system indicating the recognition system's choice as to the sound occurring during a particular speech interval. Often the alphabet of potential phonetic labels is chosen to be the same as the alphabet of phonemes, but there is no requirement that they be the same. Some systems may distinguish between phonemes or phonemic labels on the one hand and phones or phonetic labels on the other hand. Strictly speaking, a phoneme is a linguistic abstraction. The sound labels that represent how a word is supposed to be pronounced, such as those taken from a dictionary, are phonemic labels. The sound labels that represent how a particular instance of a word is spoken by a particular speaker are phonetic labels. The two concepts, however, are intermixed and some systems make no distinction between them.

“Spotting” is the process of detecting an instance of a speech element or sequence of speech elements by directly detecting an instance of a good match between the model(s) for the speech element(s) and the acoustic observations in an interval of speech without necessarily first recognizing one or more of the adjacent speech elements.

“Pruning” is the act of making one or more active hypotheses inactive based on the evaluation of the hypotheses. Pruning may be based on either the absolute evaluation of a hypothesis or on the relative evaluation of the hypothesis compared to the evaluation of some other hypothesis.

“Pruning threshold” is a numerical criterion for making decisions of which hypotheses to prune among a specific set of hypotheses.

“Pruning margin” is a numerical difference that may be used to set a pruning threshold. For example, the pruning threshold may be set to prune all hypotheses in a specified set that are evaluated as worse than a particular hypothesis by more than the pruning margin. The best hypothesis in the specified set that has been found so far at a particular stage of the analysis or search may be used as the particular hypothesis on which to base the pruning margin.

“Beam width” is the pruning margin in a beam search system. In a beam search, the beam width or pruning margin often sets the pruning threshold relative to the best scoring active hypothesis as evaluated in the previous frame.

“Best found so far” Pruning and search decisions may be based on the best hypothesis found so far. This phrase refers to the hypothesis that has the best evaluation that has been found so far at a particular point in the recognition process. In a priority queue search, for example, decisions may be made relative to the best hypothesis that has been found so far even though it is possible that a better hypothesis will be found later in the recognition process. For pruning purposes, hypotheses are usually compared with other hypotheses that have been evaluated on the same number of frames or, perhaps, to the previous or following frame. In sorting a priority queue, however, it is often necessary to compare hypotheses that have been evaluated on different numbers of frames. In this case, in deciding which of two hypotheses is better, it is necessary to take account of the difference in frames that have been evaluated, for example by estimating the match evaluation that is expected on the portion that is different or possibly by normalizing for the number of frames that have been evaluated. Thus, in some systems, the interpretation of best found so far may be based on a score that includes a look-ahead score or a missing piece evaluation.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech compression or the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Language model” is a model for generating a sequence of linguistic elements subject to a grammar or to a statistical model for the probability of a particular linguistic element given the values of zero or more of the linguistic elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Stochastic grammar” is a grammar that also includes a model of the probability of each legal sequence of linguistic elements.

“Pure statistical language model” is a statistical language model that has no grammatical component. In a pure statistical language model, generally every possible sequence of linguistic elements will have a non-zero probability.

“Entropy” is an information theoretic measure of the amount of information in a probability distribution or the associated random variables. It is generally given by the formula

E= [symbol] ᵢ pᵢ log(pᵢ), where the logarithm is taken base 2 and the entropy is measured in bits.

“Perplexity” is a measure of the degree of branchiness of a grammar or language model, including the effect of non-uniform probability distributions. In some embodiments it is 2 raised to the power of the entropy. It is measured in units of active vocabulary size and in a simple grammar in which every word is legal in all contexts and the words are equally likely, the perplexity will equal the vocabulary size. When the size of the active vocabulary varies, the perplexity is like a geometric mean rather than an arithmetic mean.

“Decision Tree Question” in a decision tree, is a partition of the set of possible input data to be classified. A binary question partitions the input data into a set and its complement. In a binary decision tree, each node is associated with a binary question.

“Classification Task” in a classification system is a partition of a set of target classes.

“Hash function” is a function that maps a set of objects into the range of integers {0, 1, . . . , N−1}. A hash function in some embodiments is designed to distribute the objects uniformly and apparently randomly across the designated range of integers. The set of objects is often the set of strings or sequences in a given alphabet.

“Lexical retrieval and prefiltering.” Lexical retrieval is a process of computing an estimate of which words, or other speech elements, in a vocabulary or list of such elements are likely to match the observations in a speech interval starting at a particular time. Lexical prefiltering comprises using the estimates from lexical retrieval to select a relatively small subset of the vocabulary as candidates for further analysis. Retrieval and prefiltering may also be applied to a set of sequences of speech elements, such as a set of phrases. Because it may be used as a fast means to evaluate and eliminate most of a large list of words, lexical retrieval and prefiltering is sometimes called “fast match” or “rapid match”.

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

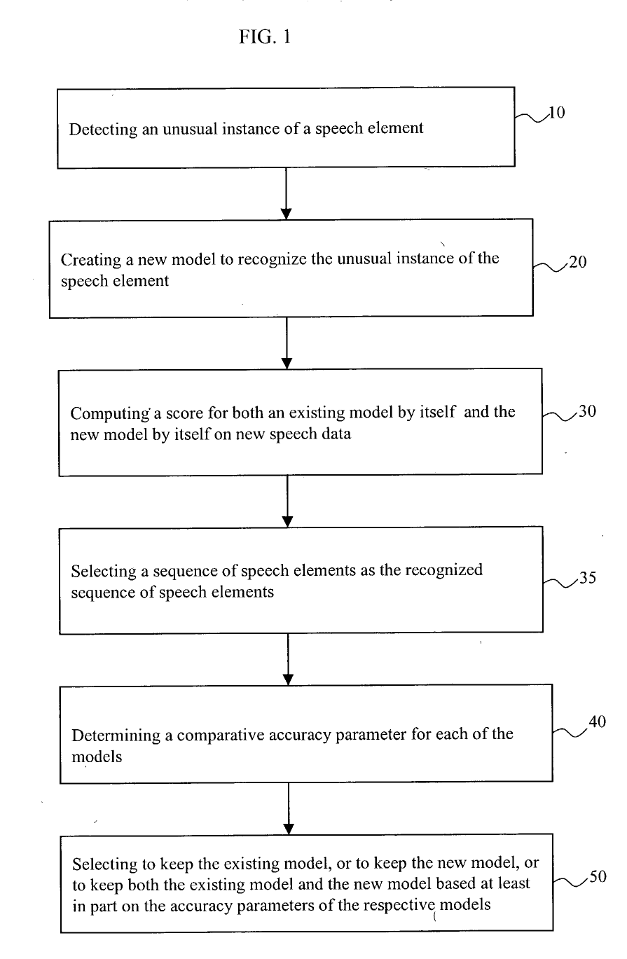

Referring now to FIG. 1, there is shown one embodiment for a speech recognition method in the context of an existing model for a speech element, comprising a block 10 for detecting an “unusual instance” of the speech element.

An “unusual speech element” is an element that has been marked as unusual either by automatic means or by user interaction. For example, a speech element may be automatically marked as unusual if the measure of the likelihood of its degree of match against the acoustic observations is worse than some predetermined threshold. The predetermined threshold may simply be some difference added to a score for an existing model for that speech element. In an interactive system, it may be marked as unusual because it has caused an error that the user has corrected, or simply because the user has directly indicated to the system that the instance is unusual.

In one embodiment of the invention, this detecting step can be performed by using an estimated likelihood of a speech element as a probability in determining that an instance of an element is unusual. However, this method may not provide optimum results if the model uses, for example, Gaussian distributions, but the true distribution for the speech element is not Gaussian, because then the Gaussian model may be a poor fit in the tail of the probability distribution. In a further embodiment, the estimated log likelihood is used merely as a measure of degree of fit to the acoustic observations. The distribution of the degree-of-fit measurement is then directly estimated, either simply as a non-parametric or a parametric distribution. For example, the system may merely count the fraction of the time that the degree-of-fit is worse than a particular value. An element would then be labeled as unusual if its degree of fit is worse than a value that occurs for less than some predetermined fraction of the instances of the speech element. For example, the threshold may be set so that only one instance in one hundred or one instance in one thousand is marked as unusual.

Referring to block 20, a new model is created specialized to recognize the unusual instance. In one embodiment for a parametric distribution such as a Gaussian distribution, the new model may be created by determining a mean for the new model based on a data value in the unusual instance, and using a variance from the existing model as the variance for the new model. In a further embodiment of the invention, the new model may be created by time aligning the unusual instance with the existing model, then creating a network with a state per frame, and for each frame using the variance from the existing model time aligned with frame and using the acoustic parameters from the frame as the mean. Note that typically the new model is created based on a single instance of speech data.

This single instance training is not restricted to models based on probability distributions. For example, a similar process may be used with certain kinds of neural networks. In particular, consider a neural network that includes nodes that can compute functions of the form

f(X)=(xᵢ−mᵢ)² or of the form f(X)=|xᵢ−mᵢ|,

where xᵢ is the i th component of the acoustic observation vector X. Then we can create a subnetwork for the neural network from the single instance of speech data by creating a new node for each component i of the acoustic observation vector X, using the observed value for mᵢ. If the existing network already has a subnetwork of this form, then the weights in that subnetwork can be copied as initial values for the weights in the new subnetwork. Otherwise, the weights in the new network could initially be set to a pre-specified value.

Note that in this context the term “model” is used to refer to a model for a single speech element. However, any hypothesis may be a set of speech elements, and possibly a sequence of speech elements, so that corresponding to that hypothesis is a set of models, and possibly a sequence of models. The match score for any hypothesis against a given set of acoustic observations is actually the match score for the concatenation of the models for the speech elements in the hypothesis. When, as in this invention, an alternate model is substituted for one or more of the speech elements in the hypothesis, the match score for the hypothesis will depend on which alternate speech element model is used in the match computation. Thus we may speak of “matching the model to the acoustic observations,” or of “matching a hypothesis that contains the model to the acoustic observations.”

Referring now to block 30, a score is computed for both the existing model by itself on new speech data and the new model by itself on new speech data by matching the respective models to the acoustic observations in the new speech data.

Referring to block 35, the recognition system then chooses a hypothesis as the recognized hypothesis for display or for other purposes. In this regards, when at least one hypothesis that uses one of the models scores better than any other hypothesis, but the best hypothesis when the hypotheses are ranked using the one model is different from the best hypothesis when the hypotheses are ranked using the other model (implicit in this difference is that one model is predicting that the instance of the speech element is less likely or not present), then in the preferred embodiment the system does not simply choose the best scoring hypothesis, as it would with normal models. Instead, the system will substantially randomly choose whether to use one model or the other model in scoring the list of hypotheses and choosing the answer. The choice probabilities in this random choice are not necessarily equal, but rather are design parameters by which the designer can trade-off the rate of potential errors by the less reliable model versus gathering information to confirm or refute the new model more quickly. This selection procedure is different from the regular recognition process because the system is not only performing recognition, but is also gathering information about the performance of both models. This random selection process circumvents the situation in which, one of the models is so sure of itself that it prevents the other model from being used, which would prevent the system from gathering feedback data on the other model. Thus, the word “randomly” is not meant to imply that the alternatives are equally likely.

Referring to block 40, a comparative accuracy parameter for each of the models is computed. In one embodiment, the step of determining a comparative accuracy parameter for each of the existing model and the new model may comprise determining if the speech element is present in the new speech data, and then determining the comparative accuracy parameter for one of the models based on whether the score for that model was higher or lower than the other of the models and based on whether the speech element represented by the existing model and the new model was present in the new speech data.

The presence of the speech element may be determined via a correction by a user, or by a machine in the case in which the recognition of the speech element is part of a larger overall system in which additional knowledge will be brought to bear in the final recognition decision. For example, phoneme recognition errors may be corrected by a system that performs word and sentence recognition and then corrects the phonemes to be consistent with the best matching sentence. Word recognition may be corrected by a system that performs sentence recognition, especially if the system has a grammar or a statistical language model with high relative redundancy (that is, relatively low perplexity). As an example, when a hypothesis in a set of hypotheses is being tested, a degree of match is determined between the existing concatenated sequence of models that comprise the hypothesis and the acoustic data and a score determined. Then a degree of match is determined between the concatenated sequence of models including the new model that comprise the hypothesis and the acoustic data and a score determined.

Then the accuracy parameter may be determined by counting the instances in which one model ranks the hypothesis for the speech element that is present ranked higher in the selected set of hypotheses than the other model. For example, if the user actively corrects the sentence as recognized, then the model that ranked the correct hypothesis higher is rewarded and the model that ranked the correct hypothesis lower is penalized.

If the user does not correct the sentence as presented, the model that was used is rewarded. If the user explicitly corrects the sentence, then the model that agrees with the correction is rewarded and the model that disagrees with the correction is penalized. Note that the rewards and penalties may be larger for such explicit corrections or implicit confirmations where the hypothesis is ranked higher in the selected set of hypotheses compared to the rewards and penalties that are made when the models are only in hypotheses that are ranked lower in the selected set of hypotheses. The rewards and penalties basically are counts used to estimate the probability that a given model will correct an error that would have otherwise been made or that the model will cause a new error. Whenever a model is used in a hypothesis that scores well enough to be in the selected set of hypotheses, there is a chance that in similar situations the model will correct an error or cause an error. Both chances are higher when the model is used in hypotheses that are higher on the list, in particular when at least one of them is used in the best scoring hypothesis. Additionally, the reward or penalty may be different depending on whether the correction was supervised (for example, a transcript was verified by prompting the user), unsupervised (no verification of correctness or no explicit error correction were received on training data), or semi-supervised (the correction was made on new speech data and not training data).

Referring now to block 50, the step is performed of selecting to keep the existing model, or to keep the new model, or to keep both the existing model and the new model with usage based, for example, on the measured performance of the respective models in situations in which one or both models are used in scoring the best hypothesis or a close call alternate hypothesis. In one example, the comparative accuracy parameters on the operations of the models for a plurality of instances of speech data should be accumulated until a difference in performance between the models is significant (for example, at significance level of 0.01). When there is a significant difference in performance, then the lower performing model would be dropped and the process can be restarted if there are any further unusual instances of the speech element.

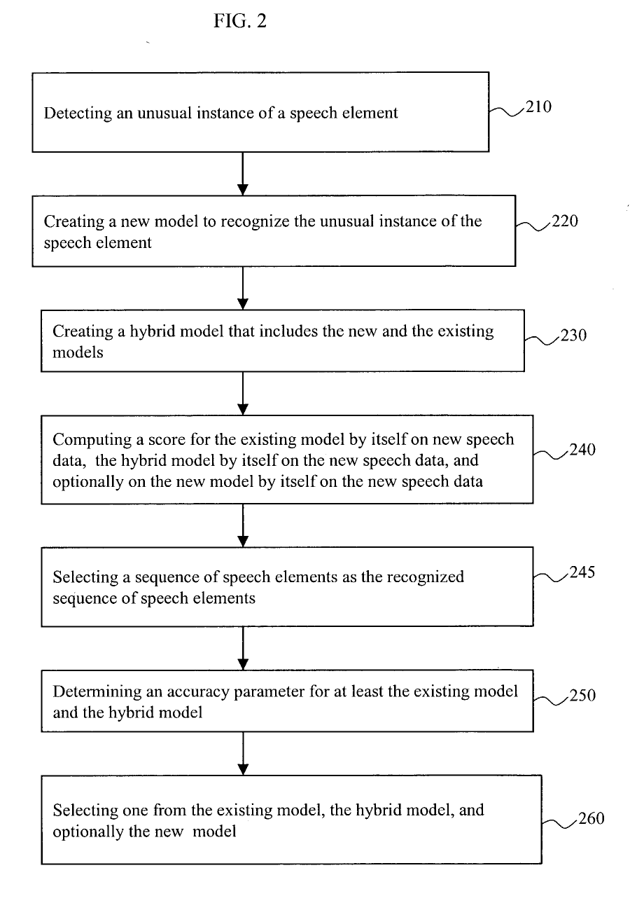

Referring now to FIG. 2, a further embodiment of the present invention is shown. Blocks 210 and 220 may be substantially the same as blocks 10 and 20, respectively in FIG. 1.

Referring to block 230, a hybrid model is created that includes the new and the existing models. In one embodiment of the hybrid model, the model represents a stochastic process in which sometimes speech is generated by the portion of the hybrid model that corresponds to the existing model and sometimes speech is generated by the portion of the hybrid model that corresponds to the new model. The general principles of the hybrid model aspect of the present invention may be implemented by a variety of different techniques, such as neural networks and Markov state space. By way of example, for a Markov state space, the hybrid model will include a representation of the probability of speech being generated by each of its existing model and the new model. However, there would not need to be a separate process by which the recognition system would need to choose whether to use the old or the new model. As known to those skilled in the art of matching hidden Markov processes to observations, after the hybrid model has been formulated the standard processes for matching a hidden Markov process could be used to compute the degree of match between the hybrid model and a set of acoustic observations without regard to how the hybrid model was derived and without regard to the fact that it has a portion originally corresponding to the existing model and a portion corresponding to the new model. The implementation may include running model training using the new hybrid model matched against previous instances in training data of the speech element being modeled. In this training process, the standard hidden Markov training procedures will assign some a posteriori probability in some of the training instances to nodes in the Markov network for the hybrid model that correspond to nodes from the new model for the unusual element. This will have the favorable effect of finding more instances or portions of instances of the speech element that match portions of the new model. This in turn will provide more data so that the parameters of the new model can be estimated more accurately. Because the present invention in some embodiments provides extra safeguards before a new or hybrid model replaces an existing model, unsupervised training may also be safely used in circumstances in which it would have been avoided in a prior art system. In particular, interactive continuous speech recognition systems often do no training of existing models when the user takes no action to correct errors. In the preferred embodiment of the present invention, any instance of the speech element for which a new or hybrid model has been created in a sentence which has been recognized without an error correction may be used as new training data.

Referring now to block 240, a score is computed for the existing model by itself on new speech data, a score is computed for the hybrid model by itself on the new speech, and a score may optionally also be computed for the new model (as described in the first embodiment) by itself on the new speech data. As an example, when a hypothesis in the selected set of hypotheses is being tested, a score may be computed for the concatenated sequence of existing models that comprise the hypothesis, then a score may be computed for the concatenated sequence of models that comprise the hypothesis but including the hybrid model for at least one instance of a speech element, and then a optionally a score may be computed for the concatenated sequence of models that comprise the hypothesis but including the new model (as described for the first embodiment) for at least one instance of its speech element.

Referring to block 245, the recognition system then selects a hypotheses as the recognized hypothesis for display or for other purposes. As in the first embodiment, it may happen that a particular hypothesis is ranked best when the ranking of the selected set of hypotheses is done using one of the models, but that a different hypothesis is ranked best when the ranking is done using the a different model. Furthermore, in one case the hypothesis that is ranked best may include an instance of the speech element being modeled by the given models while in the other case the hypothesis that is ranked best does not include an instance of the given model. In particular, this situation may occur if another unusual instance of the speech element occurs so that it poorly matches the existing model, but matches the new model well. When the best scoring hypotheses under the rankings by the respective models disagree as to whether an instance of the speech element occurs, then the system substantially randomly chooses which model to believe. As noted above, the choice probabilities in this random choice are not necessarily equal, but rather are design parameters by which the designer can trade-off the rate of potential errors by the less reliable model versus gathering information to confirm or refute the new model more quickly. This selection procedure is different from the regular recognition process because the system is not only performing recognition, but is also gathering information about the performance of both models. This random selection process circumvents the situation in which one of the models is so sure of itself that it prevents the other model from being used, which would prevent the system from gathering feedback data on the other model. Thus, the word “randomly” is not meant to imply that the alternatives are equally likely.

Referring to block 250, a comparative accuracy parameter for each of the models is then determined. In one embodiment, the actual speech elements that are present are determined, via explicit corrections by a user or by a machine if the recognition of the speech element is part of a larger system with additional knowledge, or by implicit verification with or without prompts. Then instances may be counted in which one model causes the given hypothesis to be ranked higher in the selected set of hypotheses than the other model. If the user actively corrects the sentence as recognized, then the model that caused the correct hypothesis to be ranked higher is rewarded and the model that ranked the correct hypothesis lower is penalized. If the user does not correct the sentence as presented, the model that was used is rewarded. Note that the rewards and penalties may be larger with explicit correction or implicit confirmation if a model was ranked higher in the selected set of hypotheses as compared to when the model is ranked lower on the selected set of hypotheses. Also, as noted previously, the level of reward or penalty may be determined, in part, by whether the correction was supervised, unsupervised, or semi-supervised.

Referring to block 260, the selecting step selects to keep the existing model, or to keep the hybrid model, or optionally to keep the new model, or to keep both the existing model and the hybrid model, or optionally some other combination of models, based on the measured accuracy parameters of the respective models. In one example, the accuracy parameter statistics on the operations of the models should be accumulated until a difference in performance between the models is significant (for example, at significance level of 0.01). When there is a significant difference in performance, then drop the lower performing model and the process is restarted.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A speech recognition method in the context of an existing model for a speech element, comprising:
detecting an unusual instance of the speech element;
creating a new model to recognize the unusual instance of the speech element;
computing a score for both the existing model by itself and the new model on new speech data;
determining a comparative accuracy parameter for each of the models; and
selecting to keep the existing model, or to keep the new model, or to keep both the existing model and the new model based on the comparative accuracy parameters of the respective models.

2. The method as defined in claim 1, wherein the step of determining an accuracy parameter for each model comprises:
determining if the speech element is present in the new speech data; and
determining the comparative accuracy parameter for one of the models based on whether the score for that model was higher or lower than the other of the models and based on whether the speech element was present in the new speech data.

3. The method as defined in claim 1, further comprising selecting a hypothesis as a recognized hypothesis.

4. The method as defined in claim 3, wherein the recognized hypothesis is displayed in order to receive explicit or implicit correction input.

5. The method as defined in claim 3, wherein the selecting a hypothesis step comprises, if one hypothesis ranks best when ranked using the score from one of the models of a given speech element and hypothesizes an instance of the given speech element, and a different hypothesis ranks best when ranked using the scores from the other model of the given speech element and does not hypothesize an instance of the given speech element, then the portion of the time that the models are used to determine the selection of the hypothesis as the recognized hypothesis, is determined substantially randomly.

6. The method as defined in claim 1, further comprising
ranking a hypothesis among a list of hypotheses based at least in part on the score computed for the existing model;
ranking the hypothesis among a list of hypotheses based at least in part on the score computed for the hybrid model;
determining if the speech element represented by the hypothesis is present in the new speech data; and
determining the comparative accuracy parameter for each of the existing model and the hybrid model based on whether the score for that model was higher or lower than the other of the models and based on whether the speech element represented by the hypothesis was present in the new speech data.

7. The method as defined in claim 6, wherein if there is a correction or a confirmation, the rewards and penalties are made larger for a model that ranked its hypothesis higher in the list of hypotheses as compared to the rewards and penalties for a model that ranked its hypothesis lower in the list of hypotheses.

8. The method as defined in claim 1, further comprising training the new model.

9. The method as defined in claim 1, further comprising training the new model against previous instances of training data for the speech element being modeled.

10. The method as defined in claim 1, further comprising unsupervised training of the new model against instances of the speech element that have been recognized and not corrected.

11. The method as defined in claim 1, wherein the creating a new model step comprises determining a mean for the new model based on a data value in the unusual instance, and using a variance from the existing model as the variance for the new model.

12. The method as defined in claim 11, further comprising:
time aligning the unusual instance with the existing model;
creating a network with a state per frame; and
for each frame using the variance from the existing model time aligned with frame and using the acoustic parameters from frame as the mean.

13. The method as defined in claim 1, wherein the comparative accuracy parameter is determined at least in part by a rate of correction by a user.

14. The method as defined in claim 1, wherein the comparative accuracy parameter is determined at least in part by a rate of correction determined automatically by the use of extra knowledge.

15. A speech recognition method in the context of an existing model for a speech element, comprising:
detecting an unusual instance of the speech;
creating a new model to recognize the unusual instance of the speech element;
creating a hybrid model that includes the new and the existing models;
computing a score for at least the existing model by itself and the hybrid model on new speech data;
determining a comparative accuracy parameter for at least each of the existing model and the hybrid model; and
selecting to keep the existing model, or to keep the hybrid model, or to keep both the existing model and the hybrid model based on the comparative accuracy parameters of the respective models.

16. The method as defined in claim 15, wherein the hybrid model comprises modeling the speech element as being generated by a stochastic process that is a mixture distribution of the existing model and the new model.

17. The method as defined in claim 16, wherein the mixture distribution is determined by matching the hybrid model to existing training data.

18. The method as defined in claim 15, wherein a score is calculated for the new model, a comparative accuracy parameter is determined for the new model, and wherein the selecting step may include selecting the new model.

19. The method as defined in claim 15, further comprising
ranking a hypothesis within a list of hypotheses based at least in part on the score computed for the existing model;
ranking the hypothesis within a list of hypotheses based at least in part on the score computed for the hybrid model; and
determining if the speech element represented by the hypothesis is present in the new speech data; and
determining the comparative accuracy parameter for each of the existing model and the hybrid model based on whether the score for that model was higher or lower than the other of the models and based on whether the speech element represented by the hypothesis was present in the new speech data.

20. The method as defined in claim 15, further comprising selecting a hypothesis as a recognized hypothesis.

21. The method as defined in claim 20, wherein the recognized hypothesis is displayed in order to receive explicit or implicit correction input.

22. The method as defined in claim 20, wherein the selecting a hypothesis step comprises, if one hypothesis ranks best when ranked using the score from one of the models of a given speech element and hypothesizes an instance of the given speech element, and a different hypothesis ranks best when ranked using the scores from the other model of the given speech element and does not hypothesize an instance of the given speech element, then the portion of the time that the models are used to determine the selection of the hypothesis as the recognized hypothesis, is determined substantially randomly.

23. The method as defined in claim 20, wherein if there is a correction or a confirmation, the rewards and penalties are made larger for a model that ranked its hypothesis higher in the list of hypotheses as compared to the rewards and penalties for a model that ranked its hypothesis lower in the list of hypotheses.

24. The method as defined in claim 15, further comprising training the hybrid model.

25. The method as defined in claim 15, further comprising training the hybrid model against previous instances of training data for the speech element being modeled.

26. The method as defined in claim 15, further comprising unsupervised training of the hybrid model against instances of the speech element that have been recognized and not corrected.

27. The method as defined in claim 15, wherein the creating a new model step comprises determining a mean for the new model based on a data value in the unusual instance, and using a variance from the existing model as the variance for the new model.

28. The method as defined in claim 27, further comprising:
time aligning the unusual instance with the existing model;
creating a network with a state per frame; and
for each frame using the variance from the existing model time aligned with frame and using the acoustic parameters from frame as the mean.

29. The method as defined in claim 15, wherein the comparative accuracy parameter is determined at least in part by a rate of correction by a user.

30. The method as defined in claim 15, wherein the comparative accuracy parameter is determined at least in part by a rate of correction determined automatically by the use of extra knowledge.

31. A program product for speech recognition in the context of an existing model for a speech element, comprising machine-readable program code for causing, when executed, a machine to perform the following method steps:
detecting an unusual instance of the speech element;
creating a new model to recognize the unusual instance of the speech element;
computing a score for both the existing model by itself and the new model on new speech data;
determining a comparative accuracy parameter for each of the models; and
selecting to keep the existing model, or to keep the new model, or to keep both the existing model and the new model based on the comparative accuracy parameters of the respective models.

32. The program product as defined in claim 31, wherein the step of determining an accuracy parameter for each model comprises:
determining if the speech element is present in the new speech data; and
determining the comparative accuracy parameter for one of the models based on whether the score for that model was higher or lower than the other of the models and based on whether the speech element was present in the new speech data.

33. The program product as defined in claim 31, further comprising program code for selecting a hypothesis as a recognized hypothesis.

34. The program product as defined in claim 33, wherein the recognized hypothesis is displayed in order to receive explicit or implicit correction input.

35. The program product as defined in claim 33, wherein the selecting a hypothesis step comprises, if one hypothesis ranks best when ranked using the score from one of the models of a given speech element and hypothesizes an instance of the given speech element, and a different hypothesis ranks best when ranked using the scores from the other model of the given speech element and does not hypothesize an instance of the given speech element, then the portion of the time that the models are used to determine the selection of the hypothesis as the recognized hypothesis, is determined substantially randomly.

36. The program product as defined in claim 31, further comprising program code for
ranking a hypothesis among a list of hypotheses based at least in part on the score computed for the existing model;
ranking the hypothesis among a list of hypotheses based at least in part on the score computed for the hybrid model; and
determining if the speech element represented by the hypothesis is present in the new speech data; and
determining the comparative accuracy parameter for each of the existing model and the hybrid model based on whether the score for that model was higher or lower than the other of the models and based on whether the speech element represented by the hypothesis was present in the new speech data.

37. The program product as defined in claim 36, wherein if there is a correction or a confirmation, the rewards and penalties are made larger for a model that ranked its hypothesis higher in the list of hypotheses as compared to the rewards and penalties for a model that ranked its hypothesis lower in the list of hypotheses.

38. The program product as defined in claim 31, further comprising program code for training the new model.

39. The program product as defined in claim 31, further comprising program code for training the new model against previous instances of training data for the speech element being modeled.

40. The program product as defined in claim 31, further comprising program code for unsupervised training of the new model against instances of the speech element that have been recognized and not corrected.

41. The program product as defined in claim 31, wherein the creating a new model step comprises determining a mean for the new model based on a data value in the unusual instance, and using a variance from the existing model as the variance for the new model.

42. The program product as defined in claim 31, further comprising program code for:
time aligning the unusual instance with the existing model;
creating a network with a state per frame; and
for each frame using the variance from the existing model time aligned with frame and using the acoustic parameters from frame as the mean.

43. The program product as defined in claim 31, wherein the comparative accuracy parameter is determined at least in part by a rate of correction by a user.

44. The program product as defined in claim 31, wherein the comparative accuracy parameter is determined at least in part by a rate of correction determined automatically by the use of extra knowledge.

45. A program product for speech recognition in the context of an existing model for a speech element, comprising machine-readable program code for causing, when executed, a machine to perform the following method steps:
detecting an unusual instance of the speech;
creating a new model to recognize the unusual instance of the speech element;
creating a hybrid model that includes the new and the existing models;
computing a score for at least the existing model by itself and the hybrid model on new speech data;
determining a comparative accuracy parameter for at least each of the existing model and the hybrid model; and
selecting to keep the existing model, or to keep the hybrid model, or to keep both the existing model and the hybrid model based on the comparative accuracy parameters of the respective models.

46. The program product as defined in claim 45, wherein the hybrid model comprises modeling the speech element as being generated by a stochastic process that is a mixture distribution of the existing model and the new model.

47. The program product as defined in claim 46, wherein the mixture distribution is determined by matching the hybrid model to existing training data.

48. The program product as defined in claim 45, wherein a score is calculated for the new model, a comparative accuracy parameter is determined for the new model, and wherein the selecting step may include selecting the new model.

49. The program payment as defined in claim 45, further comprising program code for
ranking a hypothesis among a list of hypotheses based at least in part on the score computed for the existing model;
ranking the hypothesis among a list of hypotheses based at least in part on the score computed for the hybrid model; and
determining if the speech element represented by the hypothesis is present in the new speech data; and
determining the comparative accuracy parameter for each of the existing model and the hybrid model based on whether the score for that model was higher or lower than the other of the models and based on whether the speech element represented by the hypothesis was present in the new speech data.

50. The program product as defined in claim 45, further comprising program code for selecting a hypothesis as a recognized hypothesis.

51. The program product as defined in claim 50, wherein the recognized hypothesis is displayed in order to receive explicit or implicit correction input.

52. The program product as defined in claim 50, wherein the selecting a hypothesis step comprises, if one hypothesis ranks best when ranked using the score from one of the models of a given speech element and hypothesizes an instance of the given speech element, and a different hypothesis ranks best when ranked using the scores from the other model of the given speech element and does not hypothesize an instance of the given speech element, then the portion of the time that the models are used to determine the selection of the hypothesis as the recognized hypothesis, is determined substantially randomly.

53. The program product as defined in claim 50, wherein if there is a correction or a confirmation, the rewards and penalties are made larger for a model that ranked its hypothesis higher in the of hypotheses as compared to the rewards and penalties for a model that ranked its hypothesis lower in the of hypotheses.

54. The program product as defined in claim 45, further comprising program code for training the hybrid model.

55. The program product as defined in claim 45, further comprising program code for training the hybrid model against previous instances of training data for the speech element being modeled.

56. The program product as defined in claim 45, further comprising program code for unsupervised training of the hybrid model against instances of the speech element that have been recognized and not corrected.

57. The program product as defined in claim 45, wherein the creating a new model step comprises determining a mean for the new model based on a data value in the unusual instance, and using a variance from the existing model as the variance for the new model.

58. The program product as defined in claim 57, further comprising program code for:
time aligning the unusual instance with the existing model;
creating a network with a state per frame; and
for each frame using the variance from the existing model time aligned with frame and using the acoustic parameters from frame as the mean.

59. The program product as defined in claim 45, wherein the comparative accuracy parameter is determined at least in part by a rate of correction by a user.

60. The program product as defined in claim 45, wherein the comparative accuracy parameter is determined at least in part by a rate of correction determined automatically by the use of extra knowledge.

61. A system for speech recognition in the context of an existing model for a speech element, comprising:
a component for detecting an unusual instance of the speech;
a component for creating a new model to recognize the unusual instance of the speech element;
a component for computing a score for both the existing model by itself and the new model on new speech data;
a component for determining a comparative accuracy parameter for each of the models; and
a component for selecting to keep the existing model, or to keep the new model, or to keep both the existing model and the new model based on the comparative accuracy parameters of the respective models.

62. A system for speech recognition in the context of an existing model for a speech element, comprising:
a component for detecting an unusual instance of the speech;
a component for creating a new model to recognize the unusual instance of the speech element;
a component for creating a hybrid model that includes the new and the existing models;
a component for computing a score for at least the existing model by itself and the hybrid model on new speech data;
a component for determining a comparative accuracy parameter for at least each of the existing model and the hybrid model; and
a component for selecting to keep the existing model, or to keep the hybrid model, or to keep both the existing model and the hybrid model based on the comparative accuracy parameters of the respective models.
